(19) United States
(12) Patent Application Publication
(10) Pub. No.: US 2012/0325231 A1
(43) Pub. Date: Dec. 27, 2012

(54) FILTERS HAVING IMPROVED DEGRADATION AND METHODS OF MAKING THEM

(75) Inventors: Steven Anthony Wilson, Kingsport, TN (US); Jeremy Kenneth Steach, Kingsport, TN (US); Jerry Steven Fauver, Kingsport, TN (US)

(73) Assignee: Eastman Chemical Company, Kingsport, TN (US)

(21) Appl. No.: 13/167,180

(22) Filed: Jun. 23, 2011

(51) Int. Cl. A24D 3/10; B05D 5/00

(52) U.S. Cl. 131/332; 427/244

(57) ABSTRACT

Degradable filters are disclosed, as well as methods of making them, that include the steps of applying a plasticizer containing a photoactive agent to cellulose ester fibers to obtain plasticized cellulose ester fibers; and forming the plasticized cellulose ester fibers into a filter. The cellulose ester fibers may comprise cellulose acetate, the plasticizer may be triacetin, and the photoactive agent may include a number of types of titanium dioxide, for example mixed phase titanium dioxide particles. The filters are useful, for example, in preparing cigarette filters.

### FIELD OF THE INVENTION

The present invention relates to filters, and specifically, to filters such as cigarette filters that exhibit improved degradation.

### BACKGROUND OF THE INVENTION

Typical cigarette filters are made from a continuous-filament tow band of cellulose acetate-based fibers, called cellulose acetate tow, or simply acetate tow. The use of acetate tow to make filters is described in various patents, and the tow may be plasticized. See, for example, U.S. Pat. No. 2,794,239.

Instead of continuous fibers, staple fibers may be used which are shorter, and which may assist in the ultimate degradation of the filters. See, for example, U.S. Pat. No. 3,658,626 which discloses the production of staple fiber smoke filter elements and the like directly from a continuous filamentary tow. These staple fibers also may be plasticized.

Acetate tow for cigarette fibers is typically made up of Y-shaped, small-filament-denier fibers which are intentionally highly crimped and entangled, as described in U.S. Pat. No. 2,953,838. The Y-shape allows optimum cigarette filters with the lowest weight for a given pressure drop compared to other fiber shapes. See U.S. Pat. No. 2,829,027. The small-filament-denier fibers, typically in the range of 1.6-8 denier per filament (dpf), are used to make efficient filters. In constructing a filter, the crimp of the fibers allows improved filter firmness and reduced tow weight for a given pressure drop.

The conversion of acetate tow into cigarette filters may be accomplished by means of a tow conditioning system and a plugmaker, as described, for example, in U.S. Pat. No. 3,017,309. The tow conditioning system withdraws the tow from the bale, spreads and de-registers (“blooms”) the fibers, and delivers the tow to the plugmaker. The plugmaker compresses the tow, wraps it with plugwrap paper, and cuts it into rods of suitable length. To further increase filter firmness, a nonvolatile solvent may be added to solvent-bond the fibers together. These solvent-bonding agents are called plasticizers in the trade, and historically have included triacetin (glycerol triacetate), diethylene glycol diacetate, triethylene glycol diacetate, tripropionin, acetyl triethyl citrate, and triethyl citrate. Waxes have also been used to increase filter firmness. See, for example, U.S. Pat. No. 2,904,050.

Conventional plasticizer fiber-to-fiber bonding agents work well for bonding and selective filtration. However, plasticizers typically are not water-soluble, and the fibers will remain bonded over extended periods of time. In fact, conventional cigarette filters can require years to degrade and disintegrate when discarded, due to the highly entangled nature of the filter fibers, the solvent bonding between the fibers, and the inherent slow degradability of the cellulose acetate polymer. Attempts have therefore been made to develop cigarette filters having improved degradability.

U.S. Pat. No. 5,947,126 discloses a bundle of cellulose acetate fibers bonded with a water-soluble fiber-to-fiber bonding agent. The bonded fibers are wrapped in a paper having opposing ends secured together with a water-soluble plug wrap adhesive, and a plurality of cuts are made to extend more than one half way through the bundle wrapped fibers. A tobacco smoke filter is thus provided that disintegrates and degrades in a relatively short period of time.

U.S. Pat. No. 5,947,127 discloses a filter rod produced by adding a water-soluble polymer in the form of an aqueous solution or dispersion, or in a particulate form, to a tow of cellulose ester fiber. The tobacco filter is said to be highly wet-disintegratable and, hence, contributes to mitigation of environmental pollution. The environmental degradability of the fiber can be increased by incorporating a biodegradation accelerator such as citric acid, tartaric acid, malic acid, etc. and/or a photodegradation accelerator such as anatase-form titanium dioxide, or titanium dioxide may be provided as a whitening agent.

Research Disclosure, June 1996, pp. 375-77 discloses that the use of plasticizers used to form filters from acetate tow decrease the degradation of cigarette filters by holding the fibers together, but that simply leaving off the plasticizer will not allow the rapid disintegration of the filters in the environment due to fiber entanglement. The authors therefore propose environmentally disintegratable filters made using uncommon types of tow, that is, fibers which have properties that will significantly reduce entanglement when wet.

U.S. Pat. No. 7,435,208 discloses cigarette filters that comprise an elongate filter component having a longitudinal axis. A plurality of spaced-apart slits generally perpendicular to the longitudinal axis of the filter component partially extend into the component. The slits enable the filter to disintegrate and more readily degrade after being used and discarded.

U.S. Pat. Nos. 5,491,024 and 5,647,383 disclose a man-made fiber comprising a cellulose ester and 0.05 to 5.0% by weight of a titanium dioxide having an average particle size of less than 100 nanometers. The titanium dioxide is added to the “dope” (i.e., the solvated cellulose ester) prior to extrusion into the tow. Addition of the titanium dioxide may be at any convenient point prior to extrusion.

U.S. Pat. No. 5,512,230 discloses a method for spinning a cellulose acetate fiber having a low degree of substitution per anhydroglucose unit (DS/AGU) of the cellulose acetate. The addition of 5 to 40 weight percent water to cellulose acetate (CA)/acetone spinning solutions (dopes) is said to produce dopes that will allow fibers to be solvent spun using CA with a DS/AGU from 1.9 to 2.2.

U.S. Pat. No. 5,970,988 discloses cellulose ester fibers having an intermediate degree of substitution per anhydroglucose unit (DS/AGU) that contain pigments which act as photooxidation catalysts. The fibers are useful as filter materials for tobacco products. The filter materials thus provided are easily dispersible and biodegradable and do not persist in the environment. The pigment may be titanium dioxide and is provided within the fiber, but in amounts greater than are typical for use as a whitening agent.

U.S. Patent Publication No. 2009/0151738 discloses a degradable cigarette filter that includes a filter element of a bloomed cellulose acetate tow, a plug wrap surrounding the filter element, and either a coating or a pill in contact with the tow. The coating and/or pill may be composed of a material adapted to catalyze hydrolysis of the cellulose acetate tow and a water-soluble matrix material such that when water contacts the water-soluble matrix material, the material adapted to catalyze hydrolysis is released and catalyzes the hydrolysis, and subsequent degradation, of the cellulose acetate tow.

WO 2010/017989 discloses a photodegradable plastic comprising cellulose esters and also, if appropriate, additives. The photodegradable plastic comprises a dispersed photocatalytic carbon-modified titanium dioxide. The photodegradable plastic is said to exhibit a surprisingly high increase in photocatalytic degradability when compared with products in which a conventional or other modified titanium dioxide is used. The photodegradable plastic can, for example, first be further processed to give a filter tow.

WO 2009/093051 and U.S. Patent Publication No. 2011/0023900 discloses a tobacco smoke filter or filter element comprising a cylindrical plug of a substantially homogeneous filtering material of circumference between 14.0 and 23.2 mm, wherein the substantially homogeneous filtering material comprises a plurality of randomly oriented staple fibers.

The photocatalytic activity of mixed-phase titanium dioxide has been investigated. See “Explaining the enhanced photocatalytic activity of Degussa P25 mixed-phase TiO2 using EPR”, J. Phys. Chem. B 107 (2003) 4545-4549. See also “Probing reaction mechanisms in mixed phase TiO2 by EPR”, Journal of Electron Spectroscopy and Related Phenomena, 150 (2006) 155-163.

Titanium Dioxide P25, Manufacture-Properties-Applications, Technical Bulletin Fine Particles, Number 80, Degussa Aerosil & Silanes Product Literature (Undated) discusses commercial uses of mixed-phase titanium dioxide, including use as a photocatalyst and as a photo-semiconductor.

U.S. Pat. No. 5,720,803 discloses a composition comprising a cellulose ester including at least 10 weight % of a low-substituted cellulose ester having an average degree of substitution not exceeding 2.15 and giving a 4-week decomposition rate of at least 60 weight % as determined using the amount of evolution of carbon dioxide as an indicator in accordance with ASTM 125209-91. The composition may contain a plasticizer, an aliphatic polyester, a photolysis accelerator such as anatase type titanium dioxide or a biodegradation accelerator such as organic acids and their esters. The low-substituted cellulose ester may be a cellulose ester having an average degree of polymerization from 50 to 250, an average degree of substitution from 1.0 to 2.15 and a residual alkali metal/alkaline earth metal-to-residual sulfuric acid equivalent ratio of 0.1 to 1.1. The biodegradable cellulose ester composition is said to be suitable for the manufacture of various articles including fibrous articles such as tobacco filters.

U.S. Pat. No. 5,478,386 discloses a composition that includes a cellulose ester including at least 10 weight % of a low-substituted cellulose ester having an average degree of substitution not exceeding 2.15. The composition may contain a plasticizer, an aliphatic polyester, a photolysis accelerator such as anatase-type titanium dioxide, or a biodegradation accelerator such as organic acids and their esters.

U.S. Pat. No. 5,242,880 discloses novel titania comprising anatase titanium dioxide and sodium, potassium, calcium, magnesium, barium, zinc, or magnesium salts of sulfuric or phosphoric acid. The titania are said to be useful in the pigmentation of oxidizable polymers, while at the same time providing a catalyst system for the photooxidation of the oxidizable polymers.

U.S. Pat. No. 5,804,296 discloses a composition comprising a cellulose acetate or other cellulose ester, and an anatase-type titanium oxide having a specific surface area of not less than 30 m²/g, a primary particle size of 0.001 to 0.07 μm, or a specific surface area of not less than 30 m²/g and a primary particle size of 0.001 to 0.07 μm. For improving the photodegradability and the dispersibility, the surface of the titanium oxide may be treated with a phosphoric acid salt or other phosphorus compound, a polyhydric alcohol, an amino acid or others. The composition may further contain a plasticizer and/or an aliphatic polyester, a biodegradation accelerator (e.g. organic acids or esters thereof).

WO 1995/29209 discloses pigmented cellulose acetate filaments produced by mixing a dispersion of titanium dioxide in a carboxylate ester of a polyhydric alcohol with cellulose acetate and a solvent for cellulose acetate. The resulting dispersion is dry spun to produce pigmented cellulose acetate filaments.

Balázs, Nándor et al.; “The effect of particle shape on the activity of nanocrystalline TiO2 photocatalysts in phenol decomposition”; Applied Catalysis B: Environmental, 84 (2008), pp. 356-362, investigated the effect of the morphology, that is spherical versus polyhedral, on the photocatalytic activity of nanocrystalline titanium dioxide photocatalysts.

Byrne et al., in “Characterization of HF-catalyzed silica gels doped with Degussa P25 titanium dioxide”; Journal of Non-Crystalline Solids, 355 (2009), pp. 525-530, synthesized SiO2/TiO2 composites by adding Degussa P25 TiO2 to a liquid sol that was catalyzed by HNO3 and HF acids. The composites were then characterized by several different analytical techniques.

Hurum, D. C. et al., in “Probing reaction mechanisms in mixed phase TiO2 by EPR”; Journal of Electron Spectroscopy and Related Phenomena, 150 (2006), pp. 155-163, investigated charge separation processes in mixed phase TiO2 photocatalysts by electron paramagnetic resonance spectroscopy.

Janus, M. et al., in “Carbon-modified TiO2 photocatalyst by ethanol carbonisation”; Applied Catalysis B: Environmental; 63 (2006), pp. 272-276, investigated the effect on photocatalytic activity of modifying titanium dioxide powder by carbon via ethanol carbonization.

Janus, M. et al., in “Carbon Modified TiO2 Photocatalyst with Enhanced Adsorptivity for Dyes from Water”; Catal. Lett.; 131 (2009), pp. 506-511, obtained a new photocatalyst by modifying a commercial anatase titanium dioxide in a pressure reactor in an ethanol atmosphere. The photocatalytic activity of the material was tested during three azo dyes decompositions.

Lu, Xujie et al., in “Intelligent Hydrated-Sulfate Template Assisted Preparation of Nanoporous TiO2 Spheres and Their Visible-Light Application”; ACS Applied Materials & Interfaces; December 2010, investigated nanoporous titanium dioxide spheres and their applications, including their photocatalytic activities.

Juergen Puls et al., in “Degradation of Cellulose Acetate-Based Materials: A Review”; Journal of Polymers and the Environment: Volume 19, Issue 1; 2011; pp. 152-165, reviewed studies conducted on the biogradability of cellulose acetate, including photo-degradation.

There remains a need, however, for degradable filters such as cigarette filters, and especially those that may be fabricated using existing equipment, and that do not require changes to the tow or to the filter once fabricated.

### SUMMARY OF THE INVENTION

In one aspect, the invention relates to methods of forming filters, for example cigarette filters, that include the steps of applying a plasticizer, having particles of a photoactive agent dispersed therein, to cellulose ester fibers to obtain plasticized cellulose ester fibers; and forming the plasticized cellulose ester fibers into a filter. In another aspect, the plasticizer may comprise one or more of: triacetin (glycerol triacetate), diethylene glycol diacetate, triethylene glycol diacetate, tripropionin, acetyl triethyl citrate, triethyl citrate, and mixtures of triacetin and one or more polyethylene glycols. In another aspect, the plasticizer may further include one or more water-soluble polymers.

In one aspect, the photoactive agent may comprise titanium dioxide. In another aspect, the photoactive agent may comprise rutile titanium dioxide or anatase titanium dioxide, or mixtures of rutile titanium dioxide and anatase titanium dioxide. In yet another aspect, the particles of the photoactive agent may comprise mixed-phase titanium dioxide particles. The mixed-phase titanium dioxide particles may comprise, for example, an anatase phase present in an amount from about 5% to about 95%, and a rutile phase present in an amount from about 5% to about 95%.

In one aspect, the particles of the photoactive agent comprise particles having an average diameter from about 1 nm to about 250 nm. In another aspect, the particles of the photoactive agent comprise particles having an average diameter from 5 nm to 50 nm. In yet another aspect, the particles of photoactive agent have a surface area from about 10 to about 300 sq. m/g.

In one aspect, the plasticizer may further comprise a cellulose ester polymer, and in another aspect, the plasticizer may further comprise a polyethylene glycol.

In one aspect, the cellulose ester fiber of the invention comprises one or more of a cellulose acetate, a cellulose propionate, a cellulose butyrate, a cellulose acetate propionate, or a cellulose acetate butyrate. In another aspect, the cellulose ester fiber comprises a cellulose acetate having a DS/AGU from about 1.8 to about 2.7, or from about 1.9 to about 2.5.

In one aspect, the methods of the invention may further comprise a step of slitting the cigarette filter one or more times.

In one aspect, the invention relates to filters, for example cigarette filters, made by the methods of the invention, and in another aspect, the invention relates to cigarettes provided with a filter made by the methods of the invention.

Further aspects of the invention are as disclosed and claimed herein.

### DETAILED DESCRIPTION

We have determined that, in the manufacture of filters, the use of a photoactive agent in the plasticizer causes an increased rate of breakdown of the resulting filter structure, as measured on filters exposed to UV radiation in an outdoor environment. This is distinguished from adding the photoactive agent to the fiber at the time the fiber is formed, for example by adding the photoactive agent to the cellulose ester dope, that is, to the cellulose ester when dissolved in acetone prior to being spun.

Without wishing to be bound by any theory, the photo degradation caused by the photoactive agent is believed to cause pitting and thus to increase the fiber's surface area, which could enhance other types of degradation mechanisms, such as biodegradation. We thus found that the plasticizer was sufficiently well distributed, even with the photoactive agent particles present in significant quantities, that the photoactive agent would serve to increase the rate of breakdown of the resulting filter structure, although typically not to the same extent as when the particles were added directly into the fiber during manufacture. We found also that the particles did not interfere unduly with fiber bonding, such that good filter firmness was maintained.

As used herein, the term “plasticizer” is intended to describe a solvent that, when applied to cellulose ester fibers, solvent-bonds the fibers together. Plasticizers useful according to the invention include one or more of: triacetin (glycerol triacetate), diethylene glycol diacetate, triethylene glycol diacetate, tripropionin, acetyl triethyl citrate, triethyl citrate, and mixtures with one or more polyethylene glycols. The blends or mixtures may optionally contain polymers, for example water-soluble polymers such as polyvinyl acetate (PVA), polyvinyl alcohol (PVOH), polyethers, such as polyethylene glycols (also called polyethylene oxides), cellulose ethers, such as methyl cellulose, hydroxyethyl cellulose, hydroxypropyl cellulose, starches, or starch esters.

When we say that the plasticizer has particles of a photoactive agent dispersed therein, we mean in one aspect that the photoactive agent is dispersed in the plasticizer, and that the photoactive agent is thus present in the plasticizer at the time the plasticizer is applied to the fibers. However, we do not mean to exclude the possibility that the photoactive agent may be dispersed, for example, in a liquid such as a polyethylene glycol which does not itself plasticize the fibers, but that may be used to apply the photoactive agent to the fibers at the same time as the plasticizer, or shortly before or after the plasticizer is applied, such that the photoactive agent is present in admixture with the plasticizer at the time the plasticizer solvent-bonds the fibers together.

As used herein, the term “photoactive agent” means an agent that, when added to a plasticizer that is applied to a cellulose ester fiber, increases the rate at which the fiber degrades upon exposure to UV radiation. Photoactive additives useful according to the invention include especially titanium dioxide, although other photoactive metals or metal compounds may likewise be used. The titanium dioxide particles may be in rutile or anatase form, or the particles may include mixtures of the two crystalline forms present in the same particle.

In another aspect, mixed phase titanium dioxide particles may be used in which both rutile and anatase crystalline structures are present in the same particle. Thus, the amount of anatase phase present in the mixed phase particles may vary, for example, from about 2% to about 98%, as measured, for example, using x-ray diffraction measurements, or from 15% to 95%, or from 50% to 95%. The rutile phase present in the particles may likewise vary in a similar manner, for example from about 2% to about 98%, as measured by X-ray diffraction, or from 15% to 95%, or from 50% to 95%, in each case as measured using x-ray diffraction techniques. We have found these particles to be especially suitable at enhancing degradation of the filters in which they are used. Not wishing to be bound by any theory, we believe that the suitability of such mixed phase particles may be because of their improved ability to absorb visible light. The use of mixed phase titanium dioxide particles in cigarette filters, without regard to the method of incorporation, is being separately pursued in a copending application filed herewith.

A variety of titanium dioxides may thus be useful according to the invention, and may be prepared in a variety of manners. Suitable titanium dioxide particles may thus be prepared by methods that include high temperature hydrolysis.

The amount of particles provided to the plasticizer may vary within a wide range, for example, from about 0.1 to about 30 wt. %, or from 0.1 to 20 wt. %, or from 0.1 to 10 wt. %. In some aspects, the amount of titanium dioxide particles provided may depend upon the plasticizer solution viscosity. Similarly, the amount of particles provided to the filter via the plasticizer will likewise vary within a wide range, for example, from about 0.01 to about 10 wt. %, or from 0.1 to 5 wt. %, or from 0.2 to 2 wt. %.

A variety of particle sizes of titanium dioxide are useful according to the invention, for example from about 1 nm to about 10 microns, or from 1 nm to 1 micron, or from 1 nm to 500 nm, or from 1 nm to 250 nm, or from 3 nm to 100 nm, or from 5 nm to 50 nm. We have found that nanoscale particles are particularly suited for use according to the invention. Not wishing to be bound by any theory, it may be that the use of a smaller particle size allows the UV radiation to penetrate further into the fiber, so that the degradation is further from the surface, thus causing degradation deeper within the plasticized fiber.

Although the particle sizes given refer to the primary particle size, the photoactive agent may be present not just in discrete particles, but also in agglomerates. We have found that particles present as agglomerates suitably enhance degradation of the resulting filters, but the particles may be milled, for example, if desired, in order to obtain a more uniform and primary particle size.

Both coated and uncoated titanium particles are suitable for use according to the invention. Coating agents that may be applied to the titanium oxide particles include, for example, carbon coatings. Coating agents that may be incorporated on the surface or with the titanium dioxide include, for example, carbon coatings and hydrated metal sulfates (MSO₄*xH20, M=Zn, Fe, Co, Mg, etc.). Not wishing to be bound by any theory, certain coatings, for example carbon coatings, may assist in the desired photodegradation of the filters, for example by allowing visual light absorption.

The particles of photoactive agent may be dispersed in the plasticizer in any of a number of ways, for example by high shear mixing in a media mill or by the use of ultra-sonic agitation. The stability of the particles in the plasticizer, that is, the tendency of the particles to remain suspended in the plasticizer during filter manufacture, may be enhanced by adding an amount of cellulose ester to the plasticizer, for example in an amount from about 0.01% to about 10%, or from 0.1% to 6%, based on weight. Stability may be further enhanced by providing to the plasticizer an amount of a polyethylene glycol, one having a molecular weight, for example, from about 100 to about 1000, in an amount from about 0.01% to about 10%, or from 0.1% to 6%, based on weight. The cellulose ester and the polyethylene glycol may be used alone or together to enhance the stability of the particles in the plasticizer.

In one aspect, the particles of photoactive agent useful according to the invention have a relatively high surface area, for example from about 10 to about 300 sq. m/g, or from 20 to 200 sq. m/g, as measured by the BET surface area method.

Providing a photoactive agent in the plasticizer rather than the fiber allows conventional acetate tows to be used in preparing the filters, without any change in the ester or tow formulation. However, placing particles of a photoactive agent in the plasticizer may affect, for example, the viscosity of the plasticizer, especially if stabilizers such as a cellulose ester and/or a polyethylene glycol are incorporated. Thus, the stabilizer may best be chosen so as not to significantly affect the viscosity but still maintain the stability of the photoactive agent in the plasticizer, for example by providing a relatively low molecular weight cellulose ester, or polyethylene glycol, or both. Other stabilizers with hydrophobic characteristics may be chosen to be added to the plasticizer. Further, adding the photoactive agent to the plasticizer would allow the construction of enhanced degradable filters from conventional filter materials, thus reducing costs and complexity.

As used herein, the term “cellulose ester fiber” means a fiber formed from one or more cellulose esters, such as cellulose acetate, for example by melt-spinning or solvent-spinning. The cellulose esters useful according to the invention thus include, without limitation, cellulose acetates, cellulose propionates, and cellulose butyrates with varying degrees of substitution, as well as mixed esters of these, that is, cellulose acetate propionate, cellulose acetate butyrate, and cellulose acetate propionate butyrate. The cellulose ester of the present invention may be a secondary cellulose ester. Examples of suitable esters thus include cellulose acetates, cellulose acetate propionates, and cellulose acetate butyrates, as described in U.S. Pat. Nos. 1,698,049; 1,683,347; 1,880,808; 1,880,560; 1,984,147; 2,129,052; and 3,617,201, incorporated herein by reference.

Thus, although cigarette filters are traditionally made with cellulose acetate fibers, the invention is not strictly limited to traditional esters or to cigarette filters. Further, while the typical degree of substitution per anhydroglucose unit (DS/AGU) of acetate for cigarette filters is about 2.45, filters may be readily constructed with a range of acetyl levels, such as from 1.5 to 2.8, or from 1.8 to 2.7, or from 1.9 to 2.5, or for example, an average DS/AGU of about 2.0. We note that lower DS/AGU values may provide a faster degradation.

The cellulose ester fibers of the present invention can be spun into a fiber, for example by melt-spinning or by spinning from an appropriate solvent (e.g., acetone, acetone/water, tetrahydrofuran, methylene chloride/methanol, chloroform, dioxane, N,N-dimethylformamide, dimethylsulfoxide, methyl acetate, ethyl acetate, or pyridine). When spinning from a solvent, the choice of solvent depends upon the type of ester substituent and upon the DS/AGU. A suitable solvent for spinning fiber is acetone containing from 0 to 30 wt % water. For cellulose acetate having a DS/AGU of 2.4-2.6, a preferred spinning solvent is acetone containing less than 3% water. For cellulose acetate having a DS/AGU of 2.0-2.4, the preferred spinning solvent is 5-15% aqueous acetone. For cellulose acetate having a DS/AGU of 1.7 to 2.0, the preferred solvent is 15-30% aqueous acetone, that is, acetone having from 15-30 wt % water.

When melt-spinning fibers, the cellulose ester or plasticized cellulose ester may have a melt temperature, for example, from 120° C. to 250° C., or from 180° C. to 220° C. Examples of suitable plasticizers for use in melt spinning of cellulose esters include, but are not limited to, diethyl phthalate, dipropyl phthalate, dibutyl phthalate, triacetin, triethylene glycol diacetate, dioctyl adipate, polyethylene glycol-200, or polyethylene glycol-200, or polyethylene glycol-400. Preferred plasticizers for melt-spinning include triacetin, triethyl citrate, or polyethylene glycol-400. The use of the term “plasticizer” in this instance to refer to a softened cellulose ester should be distinguished from the use elsewhere in this application to refer to a solvent that melt-bonds cellulose ester fibers.

The cellulose ester fibers used may be continuous fibers, or may be staple fibers having a shorter length, rendering the fibers more susceptible to degradation. Thus, the staple fibers may have a length from about 3 to 10 mm, or from 4 to 8 mm. The staple fibers may likewise be randomly oriented.

The cellulose ester fibers useful according to the invention are typically crimped, having, for example, from 4-20 crimps per inch, or from 10 to 15 crimps per inch. The fibers may have a denier/filament (DPF), for example, of 20-0.1, or from 5-1.5 DPF. For processing, the fibers may optionally contain lubricants or processing aids such as mineral oil, used in an amount from 0.1 to 3%, or from 0.3 to 0.8% by weight.

While particulate additives are commonly added into fibers to enhance filter whiteness, these additives are typically titanium dioxide particles roughly 200 nm in size, a size which provides good light scattering but with minimal photo activity. Such titanium oxide particles commonly have an inorganic coating on the surface to enhance the particles' dispersion in spinning solutions. Titanium dioxides have not traditionally been added to the plasticizer, perhaps because it might limit the filter's hardness without enhancing the whiteness.

As noted in the background, photoactive agents have been shown to enhance filter photodegradation, but the approach has been to put the additive(s) in the fibers during the spinning process. The present invention proposes adding the titanium dioxide to the plasticizer, thus enhancing degradation and disintegration, but with no apparent effect on the bonding between the fibers or filter hardness.

The filters produced according to the invention may further incorporate other features to enhance their degradation, for example by being slit perpendicular to their long axis, or by incorporating staple fibers or other shorter fibers which tend to increase the rate of degradation in the environment. Further measures to increase the rate of degradation may include incorporating in the plasticizer one or more polymers, for example water-soluble polymers, although this may, in fact, reduce the rate of degradation if this affects the ability of the plasticizer to solubilize the ester such that the photoactive agent does not penetrate the fiber during the plasticizing step. Water-soluble polymers that may nonetheless be useful include polyvinyl acetate, polyvinyl alcohol, starches, and cellulose acetate having a DS/AGU ranging, for example, from 1.4 to1.8.

The filters produced according to the invention may have any number of additional features, for example having particulate additives such as charcoal or zeolites. They may likewise be provided with a thread, which may be colored, or with flavor beads or any other non-particulate additives.

The filters may likewise be provided with a water-soluble plug wrap adhesive to further facilitate degradation of the filter in the environment.

The novel processes and filters provided by the present invention are further illustrated by the following examples.

### EXAMPLES

### Examples

In the following examples, the filter samples were placed on the roof of a building in individual wire mesh cages to allow sufficient UV radiation to reach the filters, and were positioned approximately four inches from the ground so as to minimize the samples sitting in water puddles present on the roof top. Each roof top study consisted of ten 21 mm filter tips per example, placed in the mesh cage with the paper removed leaving only the fibers that formed the filter. The paper was removed so the fibers in the filters could be directly exposed to UV radiation, to determine the effects of the photoactive agent's role in degradability.

The filters were collected for weighing and photographing every 3 months to assess the degradation of the fibers in the filter. This process was used for all examples reported below. The results provided are the weight of the ten filter samples at each test point.

The TiO₂ pigment used in the examples was Kronos 1071, an inorganic-coated single phase anatase TiO₂ used in the fibers as a pigment or whitening agent, and having an average particle size of 210 nm.

Two photoactive TiO₂ particles were used in the examples, provided either in the fibers, in the plasticizer, or both. The first, AEROXIDE® TiO₂ P 25, manufactured by Evonik, is an ultrafine-size, uncoated mixed-phase TiO₂ having an average particle size of about 20 nm. The second, VP TiO₂ P 90, also manufactured by Evonik, is likewise an ultrafine-size, uncoated mixed phase TiO₂ having an average particle size of about 14 nm.

### Example 1

### Cigarette Filter-No TiO₂ Pigment; No Photoactive Agent; Fibers Bonded with Triacetin

Filters were constructed from cellulose acetate fibers containing no TiO₂ pigment, bonded with 10 wt. % triacetin containing no photoactive agent. The roof top outdoor weathering results are set out in Table 1.

### Examples 2A and 2B

### No TiO₂ Pigment; Fibers Bonded with Triacetin Containing One of Two Photoactive TiO₂ Particles

Filters made from cellulose acetate fibers containing no TiO₂ pigment were constructed with 10 wt. % triacetin containing 2 wt. % of an ultrafine-size uncoated mixed phase TiO₂, such that each of the filters had approximately 0.2 wt. % of the photoactive TiO₂. Example 2A was provided with AEROXIDE® TiO₂ P 25, the ultrafine-size uncoated mixed phase TiO₂ having a particle size of 20 nm. Example 2B was provided with VP TiO₂ P 90, having a particle size of 14 nm. As noted, each of these products is an uncoated mixed phase TiO₂. The roof top outdoor weathering results are set out in Table 1.

### Example 3

### Conventional Filter-TiO₂ Pigment in Fibers Bonded with Triacetin Containing No Photoactive Agent

A conventional cigarette filter, made from cellulose acetate fibers containing 0.5% wt TiO₂ pigment (Kronos 1071), was constructed with 10 wt. % triacetin containing no titanium dioxide. The TiO₂ pigment, as noted, had an average particle size of 210 nm and consisted of anatase particles with an inorganic coating. The roof top outdoor weathering results are shown in Table 1.

### Examples 4A and 4B

### TiO₂ Pigment in Fibers Bonded with Triacetin Containing Photoactive TiO₂ Particles

Cigarette filters were made from cellulose acetate fibers containing 0.5% of TiO₂ pigment, and bonded with a 10% wt addition of triacetin containing 2% wt of one of two ultrafine-size uncoated mixed phase TiO₂ such that the resulting filters had about 0.2% of the photoactive TiO₂ (in addition to the 0.5% pigment-sized TiO₂ in the fiber). Example 4A was provided with AEROXIDE® TiO₂ P 25, as already described, and Example 4B was provided with VP TiO₂ P 90. The roof top outdoor weathering results are provided in Table 1.

### Examples 5A, 5B, and 5C

### Photo Active TiO₂ Particles (Size ˜20 nm) in Fibers Which are Bonded with Triacetin Containing No Photoactive Agent

To compare the effect of photoactive TiO₂ provided in the fibers versus being added in the triacetin plasticizer, filters were constructed with cellulose acetate fibers containing varying amounts of AEROXIDE® TiO₂ P 25, the ultrafine-size, uncoated mixed-phase TiO₂ already described, present in the fibers. The fibers were bonded with triacetin containing no photoactive agent.

The filters of Example 5A were provided with 0.5 wt. % of the particles. In Example 5B, the cellulose acetate fiber was provided with 1.0 wt. % of the particles. In Example 5C, the cellulose acetate fiber was provided with 2.0 wt. % of the same particles. The roof top outdoor weathering results are set out in Table 2.

### Examples 6A and 6B

### Photo Active TiO₂ Particles (Size ˜14 nm) in Fibers Which are Bonded with Triacetin Containing No Photoactive Agent

To compare the effect of photoactive TiO₂ in the fibers versus added in the triacetin plasticizer, filters were constructed with cellulose acetate fibers containing varying amounts of VP TiO₂ P 90, the ultrafine-size, uncoated mixed-phase TiO₂ having an average particle size of about 14 nm. Example 6A was provided with 0.5 wt. % of the particles, and Example 6B was provided with 1.0 wt % of the particles. The roof top outdoor weathering results are set out in Table 2.

### Examples 7A Through 7F

### Photoactive TiO₂ Particles (Sizes ˜20 nm) in Fibers Which are Bonded with Triacetin Containing Photoactive TiO₂ Particles

In Examples 7A, 7B, and 7C, filters were constructed with cellulose acetate fibers containing varying amounts of AEROXIDE® TiO₂ P 25, the ultrafine-size (size ˜20 nm), uncoated mixed-phase TiO₂. The fibers of Example 7A were provided with 0.5 wt. % of these particles; the fibers of Example 7B were provided with 1.0 wt % of these particles, and the fibers of Example 7C were provided with 2.0 wt. % of these particles. Examples 7A, 7B and 7C were bonded with 10% wt Triacetin containing 2.0% wt of the AEROXIDE® TiO₂ P 25 ultrafine-size, uncoated mixed-phase TiO₂ (˜20 nm).

The fibers of Examples 7D, 7E, and 7F were constructed with 0.5 wt. %, 1.0 wt. %, and 2.0 wt. %, respectively, of AEROXIDE® TiO₂ P 25, the ultrafine-size, uncoated mixed-phase TiO₂ having a particle size of about 20 nm. These examples were bonded with 10 wt. % triacetin containing 2% wt of the VP TiO₂ P 90 ultrafine-size, uncoated mixed-phase TiO₂ (˜14 nm). The roof top outdoor weathering results for these examples are set out in Table 3.

### Examples 8A Through 8D

### Photoactive TiO₂ Particles (Size ˜14 nm) in Fibers Which are Bonded with Triacetin Containing One of Two Photoactive TiO₂ Particles

In these examples, filters were constructed with cellulose acetate fibers containing varying amounts of VP TiO₂ P 90, the ultrafine-size (size ˜14 nm), uncoated mixed-phase TiO₂ already described. The filters were bonded with 10% wt triacetin containing one of two ultrafine-size uncoated mixed phase TiO₂.

The fibers of Example 8A and 8C contained 0.5 wt % of the 14 nm TiO₂ particles in the cellulose acetate fiber. Example 8A was bonded with 10% triacetin containing 2.0% wt of the ultrafine-size (˜20 nm) mixed phase TiO₂ and Example 8C was bonded with 10% Triacetin containing 2.0% wt ultrafine-size (˜14 nm) mixed phase TiO₂. Example 8B and 8D contained 1.0 wt. % of the ultrafine-size, uncoated mixed-phase TiO₂ (˜14 nm) in the cellulose acetate fiber. Example 8B was bonded with 10% triacetin containing 2.0% wt ultrafine-size (˜20 nm) mixed phase TiO₂ and Example 8D was bonded with 10% Triacetin containing 2.0% wt ultrafine-size (˜14 nm) mixed phase TiO₂. The roof top outdoor weathering results for these examples are set out in Table 4.

The rod hardness was measured for all the above examples to evaluate the influence of TiO2 in the plasticizer, and all examples proved to have acceptable filter firmness of over 93% in Filtrona hardness units.

TABLE 1
Roof top outdoor weathering results for Examples 1-4B.

| | Example | | | | | |
|---|---|---|---|---|---|---|
| | 1 | 2A | 2B | 3 | 4A | 4B |
| Kronos 1071 | 0 | 0 | 0 | 0.5 | 0.5 | 0.5 |
| TiO2 in Fiber, % | | | | | | |
| P 25 TiO2 in | 0 | 0.2 | 0 | 0 | 0.2 | 0 |
| Triacetin, % | | | | | | |
| P 90 TiO2 in | 0 | 0 | 0.2 | 0 | 0 | 0.2 |
| Triacetin, % | | | | | | |
| | % Weight | % Weight | % Weight | % Weight | % Weight | % Weight |
| Time, Months | Remaining | Remaining | Remaining | Remaining | Remaining | Remaining |
| 0 | 100 | 100 | 100 | 100 | 100 | 100 |
| 3 | 93 | 73 | 75 | 92 | 74 | 81 |
| 6 | 86 | 51 | 54 | 85 | 49 | 61 |
| 9 | 83 | 40 | 46 | 79 | 41 | 53 |

TABLE 2
Roof top outdoor weathering results for Example 5-6B.

| | Example | | | | |
|---|---|---|---|---|---|
| | 5A | 5B | 5C | 6A | 6B |
| P 25 TiO2 in | 0.5 | 1.0 | 2.0 | 0 | 0 |
| Fiber, % | | | | | |
| P 90 TiO2 in | 0 | 0 | 0 | 0.5 | 1.0 |
| Fiber, % | | | | | |
| Time, | % Weight | % Weight | % Weight | % Weight | % Weight |
| Months | Remaining | Remaining | Remaining | Remaining | Remaining |
| 0 | 100 | 100 | 100 | 100 | 100 |
| 3 | 61 | 61 | 62 | 81 | 67 |
| 6 | 37 | 37 | 39 | 59 | 44 |
| 9 | 31 | 32 | 33 | 51 | 40 |

TABLE 3
Roof top outdoor weathering results for Example 7A-7F.

| | Example | | | | | |
|---|---|---|---|---|---|---|
| | 7A | 7B | 7C | 7D | 7E | 7F |
| P 25 TiO2 in | 0.5 | 1.0 | 2.0 | 0.5 | 1.0 | 2.0 |
| Fiber, % | | | | | | |
| P 25 TiO2 in | 0.2 | 0.2 | 0.2 | 0 | 0 | 0 |
| Triacetin, % | | | | | | |
| P 90 TiO2 in | 0 | 0 | 0 | 0.2 | 0.2 | 0.2 |
| Triacetin, % | | | | | | |
| | % Weight | % Weight | % Weight | % Weight | % Weight | % Weight |
| Time, Months | Remaining | Remaining | Remaining | Remaining | Remaining | Remaining |
| 0 | 100 | 100 | 100 | 100 | 100 | 100 |
| 3 | 61 | 55 | 59 | 60 | 74 | 57 |
| 6 | 35 | 33 | 35 | 36 | 45 | 35 |
| 9 | 28 | 27 | 30 | 30 | 39 | 30 |

TABLE 4
Roof top outdoor weathering results for Example 8A-8D.

| | Example | | | |
|---|---|---|---|---|
| | 8A | 8B | 8C | 8D |
| P 90 TiO2 in | 0.5 | 1.0 | 0.5 | 1.0 |
| Fiber, % | | | | |
| P 25 TiO2 in | 0.2 | 0.2 | 0 | 0 |
| Triacetin, % | | | | |
| P 90 TiO2 in | 0 | 0 | 0.2 | 0.2 |
| Triacetin, % | | | | |
| | % Weight | % Weight | % Weight | % Weight |
| Time, Months | Remaining | Remaining | Remaining | Remaining |
| 0 | 100 | 100 | 100 | 100 |
| 3 | 69 | 67 | 66 | 61 |
| 6 | 42 | 42 | 43 | 37 |
| 9 | 34 | 37 | 35 | 32 |

As can be seen from the comparison of Example 1 with Examples 2A and 2B, the addition of uncoated mixed phase TiO₂ particles to the plasticizer provided an increase in the rate of degradation in the roof top outdoor weathering study. After 9 months, the percent weight remaining of Examples 2A and 2B was 40% and 46%, respectively, but for Example 1 the percent weight remaining was 83%. For the case of no TiO₂ in the fiber, the addition of the photoactive agent to the plasticizer increased the rate of degradation by roughly 40% over 9 months.

The results were similar when we compared Example 3, containing TiO2 only as a pigment, with Examples 4A and 4B, constructed with 0.5% wt. pigment size TiO₂ in the fiber as well as either of the two photoactive agents in the plasticizer. For Examples 4A and 4B, which each contained one of the two photoactive agents, improved degradation rates of 41% and 53% weight were seen, versus 79% weight remaining for Example 3, which had no photoactive agent in the plasticizer. For this comparison, the photoactive agent in the plasticizer improved the degradation rate between 30 to 40% for the 9 month period studied.

Examples 5A-C were bonded with plasticizer containing no photoactive agent, while Examples 7A-F were bonded with one of the two photoactive agents in the plasticizer. After 9 months of roof top outdoor weathering, Examples 5A, 5B, and 5C percent weight remaining were 31%, 32%, and 33%, respectively, while Examples 7A, 7B, 7C, 7D, 7E, and 7F percent weight remaining were 28%, 27%, 30%, 30%, 39%, and 30%, respectively. For these comparisons, we saw a slight improvement of degradation rate for the cases where the photoactive agent was present in the plasticizer.

Examples 6A and 6 B filters' fibers were bonded with no photoactive agent in the plasticizer, while Examples 8A, 8B, 8C and 8D were bonded with one of the two photoactive agents in the plasticizer. The percent weights remaining for Examples 6A and 6B after 9 months of roof top outdoor weathering were 51% and 40%, respectively, while Examples 8A, 8B, 8C, and 8D percent weight remaining after 9 months were 34%, 37%, 35%, 32%, respectively. For this comparison, improvement to the degradation rate after 9 months of roof top weathering was better for Examples 8A-D when either of the photoactive agents were added to the plasticizer than Examples 6A-B when no photoactive agent was in the plasticizer. The above example comparison validated that the addition of a photoactive agent to the plasticizer improved the rate of degradation over 9 months for the filter examples studied. The invention thus allows for a simpler approach to constructing an enhanced degradable filter without changing current processes for cigarette filter manufacture.

That which is claimed is:

1. A method of forming a filter, comprising:
applying a plasticizer, having particles of a photoactive agent dispersed therein, to cellulose ester fibers to obtain plasticized cellulose ester fibers; and
forming the plasticized cellulose ester fibers into a filter.

2. The method of claim 1, wherein the plasticizer comprises one or more of: triacetin (glycerol triacetate), diethylene glycol diacetate, triethylene glycol diacetate, tripropionin, acetyl triethyl citrate, triethyl citrate, and mixtures of triacetin and one or more polyethylene glycols.

3. The method of claim 2, wherein the plasticizer further comprises one or more water-soluble polymers.

4. The method of claim 1, wherein the photoactive agent comprises titanium dioxide.

5. The method of claim 1, wherein the photoactive agent comprises rutile titanium dioxide or anatase titanium dioxide, or mixtures of rutile titanium dioxide and anatase titanium dioxide.

6. The method of claim 1, wherein the particles of the photoactive agent comprise mixed-phase titanium dioxide particles.

7. The method of claim 6, wherein the mixed-phase titanium dioxide particles comprise an anatase phase present in an amount from about 50 to about 98%, and a rutile phase present in an amount from about 50 to about 2%.

8. The method of claim 1, wherein the particles of the photoactive agent comprise particles having a diameter from about 1 nm to about 250 nm.

9. The method of claim 1, wherein the particles of the photoactive agent comprise particles having a diameter from 5 nm to 50 nm.

10. The method of claim 1, wherein the plasticizer further comprises a cellulose ester polymer.

11. The method of claim 10, wherein the plasticizer further comprises a polyethylene glycol.

12. The method of claim 1, wherein the cellulose ester fiber comprises one or more of a cellulose acetate, a cellulose propionate, a cellulose butyrate, a cellulose acetate propionate, or a cellulose acetate butyrate.

13. The method of claim 1, wherein the cellulose ester fiber comprises a cellulose acetate having a DS/AGU from about 1.8 to about 2.7

14. The method of claim 1, wherein the cellulose ester fiber comprises a cellulose acetate having a DS/AGU from about 1.9 to about 2.5.

15. The method of claim 1, further comprising a step of slitting the cigarette filter one or more times.

16. A filter made by the method of claim 1.

17. A cigarette provided with a filter made by the method of claim 1.

18. The method of claim 1, wherein the particles of photoactive agent have a surface area from about 10 to about 300 sq. m/g.

19. The filter of claim 16, wherein the amount of particles of a photoactive agent provided to the filter is from about 0.01 to about 10 wt. %, based on the weight of the filter.

20. The method of claim 1, wherein the amount of particles of a photoactive agent provided to the filter is from 0.01 to 10 wt. %, based on the weight of the filter.
